(19) United States
(12) Patent Application Publication
(10) Pub. No.: US 2018/0329540 A1
(43) Pub. Date: Nov. 15, 2018

(54) CAPACITIVE TOUCH SCREEN WITH TIME OVERLAPPED CONCURRENT SCANNING OPERATION USING CODED DRIVE SIGNALS

(71) Applicant: STMicroelectronics Asia Pacific Pte Ltd, Singapore (SG)

(72) Inventor: Kien Beng Tan, Singapore (SG)

(73) Assignee: STMicroelectronics Asia Pacific Pte Ltd, Singapore (SG)

(21) Appl. No.: 16/042,055

(22) Filed: Jul. 23, 2018

Related U.S. Application Data
(63) Continuation of application No. 14/693,211, filed on Apr. 22, 2015, now abandoned.

(51) Int. Cl. G06F 3/044; G06F 3/041

(52) U.S. Cl. CPC G06F 3/044; G06F 3/0416

(57) ABSTRACT

A capacitive sensing system includes a capacitive sensing panel with drive lines and sense lines. Each drive line includes a drive circuit. A code generator operates to generate modulation codes. A drive controller generates drive signals wherein each drive signal is modulated by one of the modulation codes. The generated drive signals are applied to the drive lines through the drive circuits. The drive controller operates to simultaneously generate the drive signals for application to a corresponding group of drive lines during a drive period. Separate groups of drive lines are sequentially driven with the same drive signals during drive periods that only partially overlap.

### CROSS-REFERENCE TO RELATED APPLICATION

This application is a continuation of U.S. application for patent Ser. No. 14/693,211, filed Apr. 22, 2015, the disclosure of which is incorporated by reference.

### FIELD OF THE INVENTION

The present disclosure generally relates to a capacitive sensor.

### BACKGROUND

Reference is made to FIG. 1 which schematically illustrates a conventional capacitive touch screen system 10. The touch screen system 10 includes a touch screen panel 10p that is formed to include an array of capacitive sense nodes 12. Each sense node 12 is located at a point where a drive (or force) line 14 crosses a sense line 16. In a common implementation, the drive and sense lines 14 and 16 are formed of a conductive material. The plurality of drive lines 14 are formed in a first material layer that is supported by a substrate. The plurality of sense lines 16 are formed in a second material layer that is also supported by the substrate. The first and second material layers are separated by a layer of dielectric material. At each sense node 12 a capacitor 12c is thus formed which is comprised of a first plate 14a (from the portion of the drive line 14 at the point of crossing), a second plate 16a (from the portion of the sense line 16 at the point of crossing) and a dielectric 18 positioned between the first and second plates. The capacitor 12c at each sense node 12 will exhibit an associated mutual (or coupling) capacitance value as known in the art.

Although the drive and sense lines 14 and 16 are illustrated as linear structures, it will be understood that this is merely one typical implementation and that it is known in the art to form drive and sense lines having shapes other than linear. For example, serially connected diamond shapes are well known in the art to form drive/sense lines.

Furthermore, although the drive and sense lines 14 and 16 are described as being located in different layers, it will be understood that this is merely one typical implementation and that it is known in the art to form the drive and sense lines in a common material layer, with the point of crossing at sense nodes 12 being provided through a conductive bridge and intervening dielectric structure.

The drive lines 14 are activated by force signals output by drive circuits 20 coupled to the drive lines. In a common implementation, the force signals output from the drive circuits 20 may comprise an AC signal such as a square wave of a certain frequency and duty cycle. The sense lines 16 are coupled to the inputs of sense circuits 22 which may operate as sense amplifiers (for example, charge amplifiers or transconductance amplifiers) to generate an output signal.

Because of the application of an AC signal to the drive lines, and the presence of a capacitive coupling to the sense lines, the output signal generated by each sense circuit 22 will be indicative of the capacitance at the sense node 12. For example, the AC signal applied by a drive circuit 20 to a given drive line 14 is coupled through the capacitor 12c at a sense node 12 to the crossing sense line 16. The sense circuit 22 coupled to the crossing sense line 16 receives the coupled AC signal and detects a signal on the sense line. The magnitude of the signal sensed varies as a function of the mutual (or coupling) capacitance for the capacitor 12c at the sense node 12.

The presence of an object, such as a human body part (for example, a finger) or device (for example, a stylus) near the sense node 12 causes a change in the mutual (or coupling) capacitance for the capacitor 12c at that sense node 12. As a result, there will be a change in the coupled AC signal, and a corresponding change in the magnitude of the signal sensed by the sense circuit 22, as a result of the object's presence and its effect on the mutual (or coupling) capacitance for the capacitor 12c at the sense node 12.

A control circuit 26 is coupled to the drive circuits 20 and sense circuits 22. The control circuit 26 includes a drive controller 28 which operates to sequentially actuate each of the drive circuits 20 to apply the AC signal to each drive line 14. The control circuit 26 further includes a signal processing circuit 30 coupled to the outputs of the sense circuits 22. For each drive controller 28 actuation of a drive circuit 20, the signal processing circuit 30 operates to read the voltage of the coupled AC signal as sensed by each of the sense circuits 22. As a result, a digitized signal value is collected by the signal processing circuit 30 from each sense node 12 of the capacitive touch screen 10. The collected digitized signal values are then processed by the signal processing circuit 30 to determine presence of the object and the location (or locations) of that object.

The drive controller 28 of the control circuit 26 conventionally operates to sequentially apply the AC signal to the drive lines 14 through the associated drive circuits 20 as shown in FIG. 2. In this configuration, the pulsed waveform of the AC signal is applied to only one drive line 14 at a time. The sense circuits 22, however, operate in parallel to simultaneously sense voltage on a plurality of the sense lines 16.

### SUMMARY

In an embodiment, a capacitive sensing system comprises: a capacitive sensing panel including a plurality of drive lines and a plurality of sense lines; a drive circuit for each drive line; a code generator configured to generate a plurality of modulation codes; a drive controller configured to generate a plurality of drive signals, each drive signal modulated by one of the generated plurality of modulation codes, the generated drive signals applied to the drive lines through the drive circuits; and wherein the drive controller is further configured to simultaneously generate the plurality of drive signals for application to a corresponding group of drive lines during a drive period, and wherein separate groups of drive lines are sequentially driven with the same drive signals during drive periods that only partially overlap.

In an embodiment, a method for capacitive sensing comprising: generating a plurality of modulation codes; generating a plurality of drive signals, each drive signal modulated by one of the generated plurality of modulation codes; applying the generated drive signals to drive lines of a capacitive sensing panel including a plurality of drive lines and a plurality of sense lines. Generating and applying the plurality of drive signals comprises: simultaneously generating the plurality of drive signals for application to a corresponding group of drive lines during a drive period; and sequentially driving separate groups of drive lines with the same drive signals during drive periods that only partially overlap.

The foregoing and other features and advantages of the present disclosure will become further apparent from the following detailed description of the embodiments, read in conjunction with the accompanying drawings. The detailed description and drawings are merely illustrative of the disclosure, rather than limiting the scope of the invention as defined by the appended claims and equivalents thereof.

### BRIEF DESCRIPTION OF DRAWINGS

Embodiments are illustrated by way of example in the accompanying figures not necessarily drawn to scale, in which like numbers indicate similar parts, and in which:

FIG. 1 is a schematic illustration of a conventional capacitive touch screen system;

FIG. 2 illustrate drive signal waveforms for the system of FIG. 1;

FIG. 3 is a schematic illustration of a capacitive touch screen system with a CDMA drive scheme;

FIGS. 4A-4D show coded AC signal waveforms;

FIG. 5 illustrates an implementation of a coded drive operation for capacitive sensing using the waveforms of FIGS. 4A-4D;

FIGS. 6A-6D show coded AC signal waveforms;

FIG. 7 illustrates an implementation of a coded drive operation for capacitive sensing using the waveforms of FIGS. 6A-6D;

FIG. 8 shows application of coded signals over time in a sequential partially overlapped manner; and

FIGS. 9A and 9B illustrate operation to assert signals on additional drive lines.

### DETAILED DESCRIPTION OF THE DRAWINGS

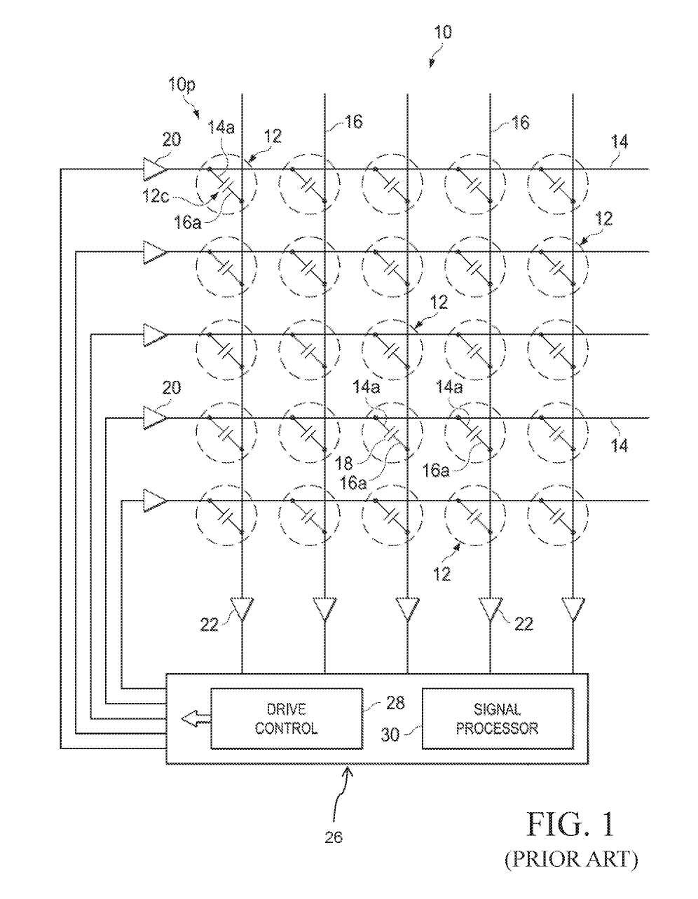

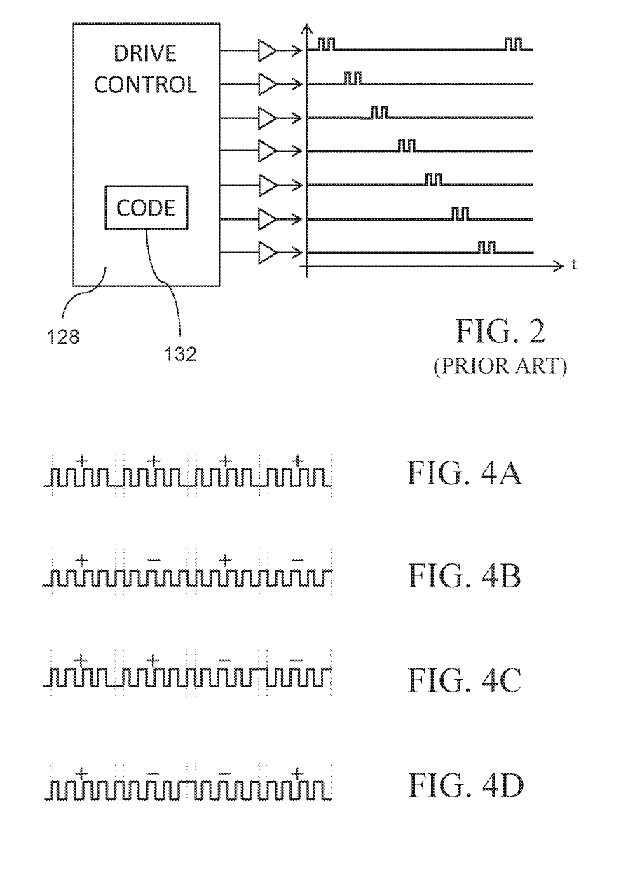

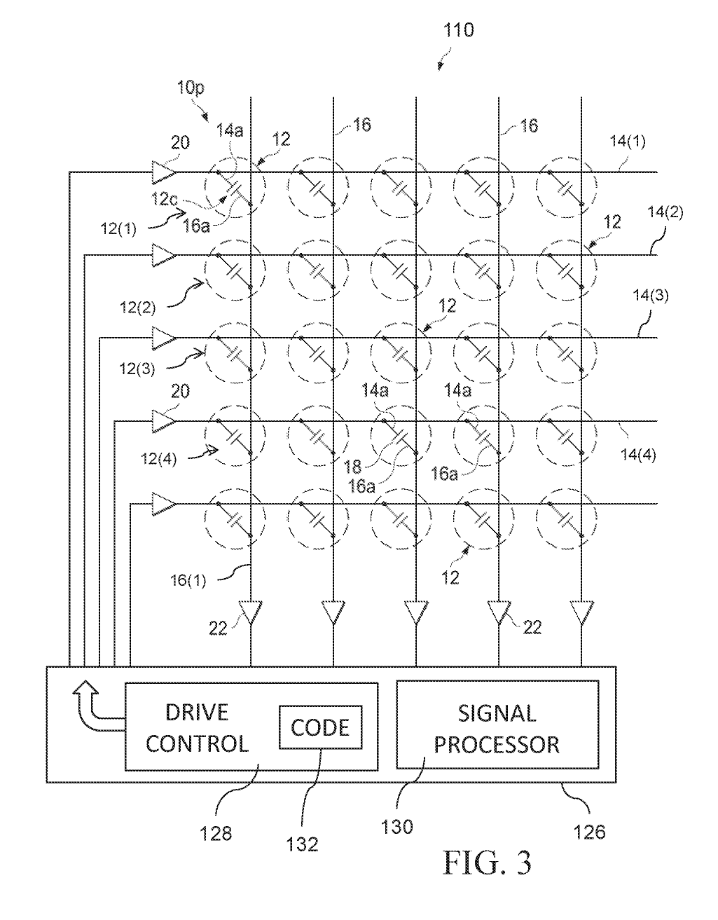

Reference is made to FIG. 3 which schematically illustrates a capacitive touch screen system 110 according to an embodiment. Like reference numbers in FIGS. 1 and 3 refer to like or similar parts for which no further description will be provided.

A control circuit 126 is coupled to the drive circuits 20 and sense circuits 22. The control circuit 126 includes a drive controller 128 which operates to selectively actuate each of the drive circuits 20 to apply an AC signal to each drive line 14. The control circuit 126 further includes a signal processing circuit 130 coupled to the outputs of the sense circuits 22. For each drive controller 128 actuation of a drive circuit 20, the signal processing circuit 130 operates to read the amplitude of a coupled AC signal as sensed by each of the sense circuits 22. As a result, a digitized signal value is collected by the signal processing circuit 130 from each sense node 12 of the capacitive touch screen 10. The collected digitized signal values are then processed by the signal processing circuit 130 to determine presence of the object and the location (or locations) of that object.

To improve the sensing operation over the implementation of FIG. 1, the drive controller 128 in FIG. 3 uses a code generator 132 to generate a plurality of distinctly modulated AC signals based on different code values for application to the drive lines 14 through the drive circuits 20. The generated distinctly modulated AC signals are selectively applied to the plurality of drive lines 14.

Consider an example with the code generator 132 operating to generate four distinct codes: <1111>, <1010>, <1100> and <1001>. The drive controller 128 responds to these codes by generating four corresponding distinctly modulated AC signals. As an example of such modulation, a data value of “1” in the code corresponds to the generation by the drive controller of an in-phase square wave signal (of a certain frequency and duty cycle) and a data value of “0” in the code corresponds to the generation by the drive controller of a logical inversion or anti-phase square wave signal. It will be understood that the use of four codes is by example only.

FIGS. 4A-4D show the modulated AC signals for these four example codes. The mathematical operand “+” above the generated signal waveform is associated with an in-phase square wave signal component of the modulated AC signal (logic “1” of the code data value) and the mathematical operand “−” above the generated signal waveform is associated with an anti-phase square wave signal component of the modulated AC signal (logic “0” of the code data value). The illustrated distinctly modulated AC signal waveforms show that the in-phase and anti-phase square wave signal components are 180° out of phase with each other.

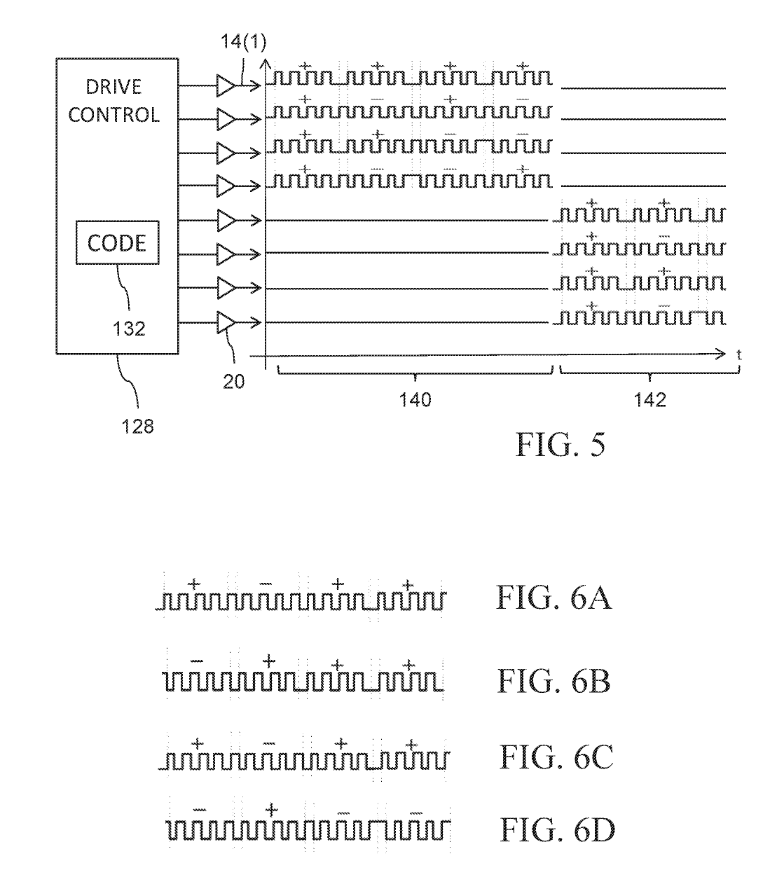

FIG. 5 shows an implementation of the foregoing example for a coded drive operation for capacitive sensing. In this implementation, the four corresponding distinctly modulated AC signals are simultaneously applied to four corresponding drive lines 14 during a coded drive period 140. The other included drive lines 14 of the panel 10p are not driven during that coded drive period 140. After expiration of that coded drive period 140, a next set of drive lines 14 in the panel 10p are driven using the same four corresponding distinctly modulated AC signals in a next coded drive period 142. This sequential drive operation using the coded signals continues until all drive lines 14 of the panel 10p have been driven. The process then repeats.

Although four drive lines 14 are shown being simultaneously driven in each of the sequential drive periods 140/142, it will be understood that the coded drive scheme is applicable to simultaneously drive fewer or more drive lines 14 as long as each of the codes is different.

With the example different codes described above, it will be noted that the overall signal amplitudes of the corresponding modulated AC signals are not uniform over the duration of the coded signal transmission within a given drive period 140/142. For example, the first coded signal shown in FIG. 4A corresponding to the code <1111> will have a different signal magnitude (due to presence of four in-phase components) than the coded signals shown in FIGS. 4B-4D corresponding to the codes <1010>, <1100> and <1001> (due to presence of two in-phase components and two anti-phase components). This difference in signal magnitudes may create second-order effects due to non-uniform loading of the drive circuits 20. The overall noise profile will also differ from drive line 14 to drive line (i.e., from row to row) across the touch screen panel 10p.

To address the foregoing issues, the code generator 132 may further be configured to generate modulation codes which ensure that the plurality of distinct modulated AC signals based on the different code values all possess a uniform overall signal amplitude. This is accomplished in one embodiment by having all modulation codes possess a same number of in-phase components and a same number of anti-phase components across a given drive period 140/142. Consider the code generator 132 operating, for example, to generate the following two distinct codes: <1011> and <0111>. FIGS. 6A-6B show the modulated AC signals for these two example codes. In this case, the overall signal amplitudes of the corresponding modulated AC signals are uniform over the duration of the coded signal transmission within a given drive period 140/142 because each signal includes three in-phase components and one anti-phase component.

This may also be accomplished in another implementation by having the modulation codes be logical inverts of each other. Consider the code generator 132 operating, for example, to generate the following two distinct codes: <1011> and <0100>. FIGS. 6C-6D show the modulated AC signals for these two example codes. In this case, the overall signal amplitudes of the corresponding modulated AC signals are uniform over the duration of the coded signal transmission within a given drive period 140/142 because the two signals offset each other.

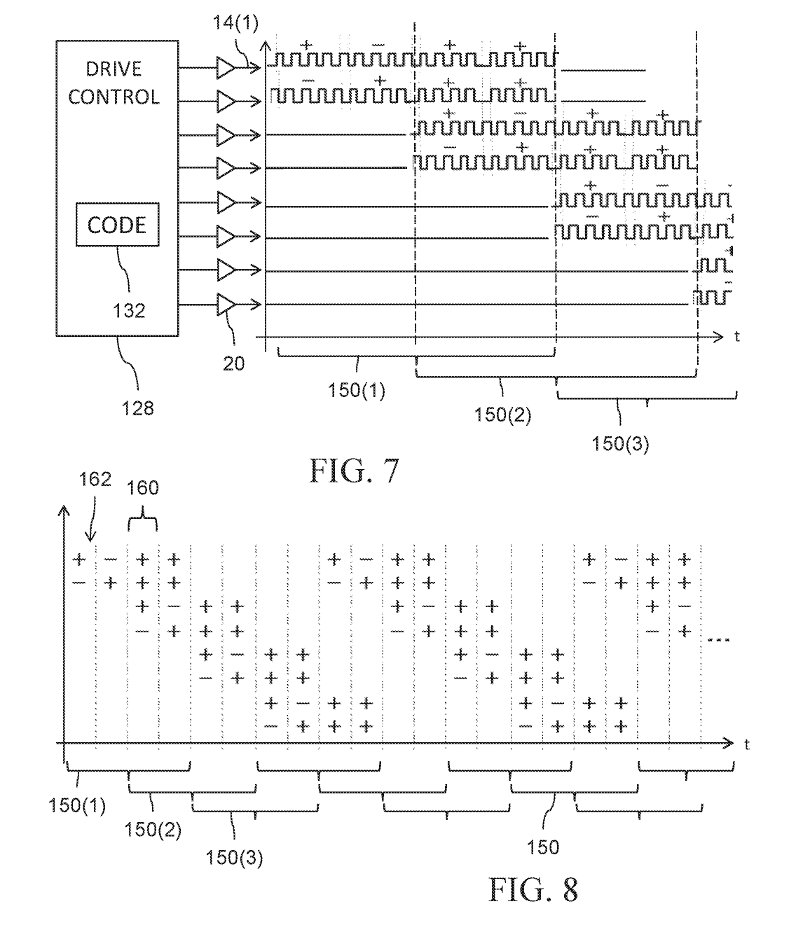

FIG. 7 shows an implementation for a coded drive operation for capacitive sensing using modulated AC signals as shown in FIGS. 6A and 6B. In this implementation, the two corresponding distinctly modulated AC signals are simultaneously applied to two corresponding drive lines 14 during each individual one of a plurality of partially overlapping coded drive periods 150. The application of the pair of distinctly modulated AC signals follows a sequential pattern in accordance with the partial overlap of the drive periods 150. Thus, the one pair of signals are applied to one pair of drive lines 14 and then another pair of signals are applied to a next pair of drive lines with a first square wave portion of the another pair of signals overlapping a second square wave portion of the one pair of signals. This sequential drive operation using the coded signals with partial overlap continues until all drive lines 14 of the panel 10p have been driven. The process then repeats as shown in FIG. 8.

The sense circuits 22 operate in parallel to simultaneously sense the signals on a plurality of the sense lines 16. The sensed signals during drive period 150(1), for example, are processed by the signal processor 126 to determine the mutual capacitance at each of the sense nodes 12 along the rows of the first pair of drive lines 14(1) and 14(2). More specifically, the sensed signals on the first sense line 16(1) during drive period 150(1) (with partial overlap of drive period 150(2)), in response to the pair of distinctly modulated AC signals on the pair of drive lines 14(1) and 14(2) (and the signals on the pair of drive lines 14(3) and 14(4)), are processed to determine the capacitance values at sense nodes 12(1) and 12(2). The sensed signals on the first sense line 16(1) during drive period 150(2) (with partial overlap of drive period 150(1) and drive period 150(3), in response to the pair of distinctly modulated AC signals on drive lines 14(3) and 14(4) (and the signals on drive lines 14(1), 14(2), 14(5) and 14(6)), are processed to determine the capacitance values at sense nodes 12(3) and 12(4). The sensed signals in the remaining drive periods 150 are similarly processed to complete acquisition of capacitance data for the remaining sense nodes 12 in the column of the panel 10p associated with the sense line 14(1). The foregoing processing operations are simultaneously performed with respect to each of the sense lines 16 in order to obtain the capacitance data for the sense nodes 12 in each of the sense line columns.

As shown in FIG. 8, each drive period 150 includes a plurality of sensing time periods 160. Each sensing time period 160 corresponds to the square wave signal for a bit of code data. The drive periods 150 in this example each includes four sensing time periods 160. The sensed signals on the sense line 16 during the four sensing time periods 160 of each drive period 150 are processed to determine the mutual capacitance at each of the sense nodes 12 for the drive lines 14 which receive the distinctly modulated AC signals.

It will be noted in FIG. 8 that at each sensing time period 160 corresponding to the square wave signal for a bit of code data, except for the first two sensing time periods at start-up of the process (reference 162), there are four square wave signals applied to four drive lines 14. These two initial sensing time periods (time slots) with less than four actuated drive lines 14 may not support a most accurate capacitance determination on the first pass, but this can in many instances be overlooked as non-material.

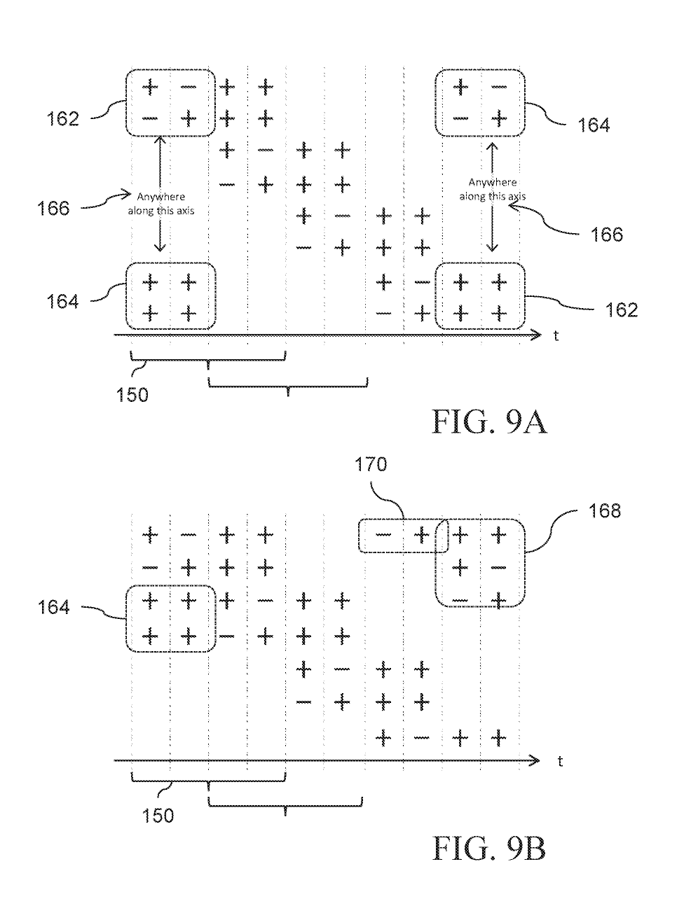

To address the foregoing issue, FIG. 9A illustrates a solution wherein a portion of a drive period 150 which would otherwise not include four square wave signals applied to four drive lines 14 (see, reference 162) is identified by the drive controller 128 which functions, in response to the generated codes to assert drive signals to any of the undriven drive lines. This ensures that each sensing time period has a same overall signal magnitude. In this example, two additional drive lines are actuated (reference 164) at portions of drive periods 150 which only include two driven lines. FIG. 9B illustrates the operation to provide additionally driven drive lines 14 for portions of drive periods which: include only two actuated drive lines in which case two additional drive lines are actuated (reference 164), include only one actuated drive line in which case three additional drive lines are actuated (reference 168), and include only three actuated drive lines in which case one additional drive line is actuated (reference 170). It will be understood that the selected additional drive lines can be any of the available drive lines as noted by reference 166 in FIG. 9A and as shown with reference 164 in FIG. 9B.

The foregoing description has provided by way of exemplary and non-limiting examples a full and informative description of one or more exemplary embodiments of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

What is claimed is:

1. A circuit for use with a capacitive sensing panel including a plurality of drive lines and a plurality of sense lines which intersect at capacitive sensing nodes, the circuit comprising:
a drive circuit for each drive line;
a drive controller configured to generate a plurality of drive signals for transmission to the capacitive sensing panel drive lines through the drive circuits, wherein the drive signals are modulated by modulation codes which have at least one in-phase code component and at least one anti-phase code component, the drive signals including at least one in-phase signal component corresponding to the at least one in-phase code component specified by the modulation code and at least one anti-phase signal component corresponding to the at least one anti-phase code component as specified by the modulation code;
wherein the drive controller is further configured to simultaneously generate a group of the drive signals, the drive signals in the group being modulated by different modulation codes, for application to a corresponding group of the drive lines during a drive period;
wherein separate groups of the drive lines are sequentially driven with the same plurality of drive signals during drive periods that only partially overlap; and
wherein the different modulation codes used to modulate the drive signals in the group have arrangements of in-phase and anti-phase code components which enable sensing of capacitance during each drive period of only the capacitive sensing nodes which are associated with the corresponding group of the drive lines.

2. The circuit of claim 1, wherein each drive period comprises a plurality of sense time periods corresponding in number to a number of code components of the modulation codes, and further comprising a processing circuit configured to process sense signals on the sense lines from each sense time period of the drive period to determine the capacitance of only the capacitive sensing nodes which are associated with the corresponding group of the drive lines.

3. The system of claim 1, wherein the modulation codes for the drive signals in the group are selected so that the drive signals generated therefrom present a uniform signal amplitude over said drive period.

4. The system of claim 1, wherein each drive period includes a plurality of sense time periods, each sense time period corresponding to a signal component of the modulation codes, and wherein the modulation codes for the drive signals in the group are selected so that the drive signals generated therefrom present a uniform signal amplitude in the sense time periods over a plurality of drive periods.

5. The system of claim 1, wherein the drive period comprises a first signal portion and a second signal portion, and wherein the sequential drive with only partial overlap of drive periods comprises driving one group in the sequence and a subsequent group in the sequence with the second signal portion of the one group overlapping the first signal portion of the subsequent group.

6. The system of claim 5, wherein the drive controller is further configured to identify instances where driving said one group in the sequence involves simultaneously driving less than a certain number of drive lines during the first signal portion and respond thereto by selectively driving additional drive lines during the first signal portion to meet said certain number.

7. The system of claim 6, wherein the drive controller generates drive signals for the selectively driven additional drive lines in accordance with the same modulation codes.

8. The system of claim 5, wherein the drive controller is further configured to identify instances where driving said subsequent group in the sequence involves simultaneously driving less than a certain number of drive lines during the second signal portion and respond thereto by selectively driving additional drive lines during the second signal portion to meet said certain number.

9. The system of claim 8, wherein the drive controller generates drive signals for the selectively driven additional drive lines in accordance with the same modulation codes.

10. A method of sensing capacitance of a capacitive sensing panel including a plurality of drive lines and a plurality of sense lines which intersect at capacitive sensing nodes, the method comprising:
generating a plurality of drive signals that are modulated by modulation codes which have at least one in-phase code component and at least one anti-phase code component, the drive signals including at least one in-phase signal component corresponding to the at least one in-phase code component specified by the modulation code and at least one anti-phase signal component corresponding to the at least one anti-phase code component as specified by the modulation code;
simultaneously driving a group of the drive signals to a corresponding group of drive lines during a drive period, the drive signals in the group being modulated by different modulation codes, wherein separate groups of the drive lines are sequentially driven with the same plurality of drive signals during drive periods that only partially overlap; and
wherein the different modulation codes used to modulate the drive signals in the group have arrangements of in-phase and anti-phase code components which enable sensing of capacitance during each drive period of only the capacitive sensing nodes which are associated with the corresponding group of the drive lines.

11. The method of claim 10, wherein each drive period comprises a plurality of sense time periods corresponding in number to a number of code components of the modulation codes, and further comprising processing sense signals on the sense lines from each sense time period of the drive period to determine the capacitance of only the capacitive sensing nodes which are associated with the corresponding group of the drive lines.

12. The method of claim 10, further comprising selecting the modulation codes for the drive signals in the group so that the drive signals generated therefrom present a uniform signal amplitude over said drive period.

13. The method of claim 10, wherein each drive period includes a plurality of sense time periods, each sense time period corresponding to a signal component of the modulation codes, and further comprising selecting the modulation codes for the drive signals in the group so that the drive signals generated therefrom present a uniform signal amplitude in the sense time periods over a plurality of drive periods.

14. The method of claim 10, wherein the drive period comprises a first signal portion and a second signal portion, and wherein the sequential drive with only partial overlap of drive periods comprises driving one group in the sequence and a subsequent group in the sequence with the second signal portion of the one group overlapping the first signal portion of the subsequent group.

15. The method of claim 14, further comprising identifying instances where driving said one group in the sequence involves simultaneously driving less than a certain number of drive lines during the first signal portion and respond thereto by selectively driving additional drive lines during the first signal portion to meet said certain number.

16. The method of claim 15, further comprising generating drive signals for the selectively driven additional drive lines in accordance with the same modulation codes.

17. The method of claim 14, further comprising identifying instances where driving said subsequent group in the sequence involves simultaneously driving less than a certain number of drive lines during the second signal portion and respond thereto by selectively driving additional drive lines during the second signal portion to meet said certain number.

18. The method of claim 17, further comprising generating drive signals for the selectively driven additional drive lines in accordance with the same modulation codes.
